(19) United States
(12) Patent Application Publication
(10) Pub. No.: US 2006/0146988 A1
(43) Pub. Date: Jul. 6, 2006

(54) Early Answer

(75) Inventor: Dennis Brian Matthews, Cameron, NC (US)

Correspondence Address: DENNIS BRIAN MATTHEWS, 119 US HWY #1 NORTH, CAMERON, NC, 28326, US

(73) Assignee: Dennis Brian Matthews, Cameron, NC (US)

(21) Appl. No.: 10/905,202

(22) Filed: Dec. 21, 2004

(51) Int. Cl. H04M 1/64

(52) U.S. Cl. 379/67.1

(57) ABSTRACT

An answering machine for preventing the ring of phones in the same location, by answering the phone before the other phones on the same line has a chance to answer. This has many uses two examples but not limited to these examples are Sleeping Baby or Third Shift workers trying to sleep during the day or night. The machine looks for the wave form of the ring on the line and answers at a fast rate, Plays a prerecorded message to the user instructing them to call back later, message recording system can take a message, or allow them to press a key on there phone and ring a ringer on the box if it is an emergency. Unit can also have the option of using a remote ringer triggered by RF signal, or by connecting to the line in another room or area that has access to the same phone line. A telephone ring is an AC signal between 15-68 HZ. We can watch the line for an AC signal when the phone is on the hook and wait for this signal by watching for a pulse (Fig A) or wave (Fig B) within this frequency range. Most of the time this signal is a square wave (Pulse), but some older phone companies still exist that use a wave form.

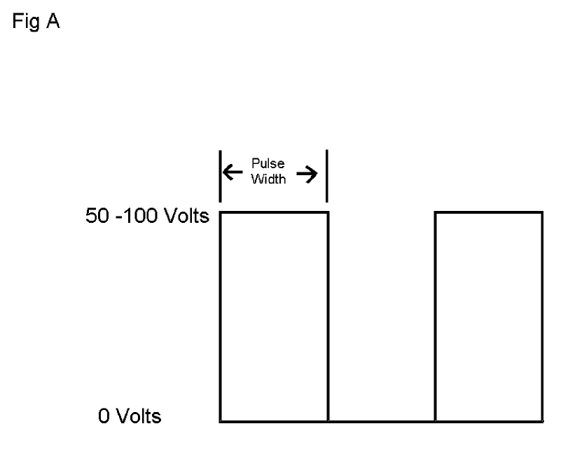

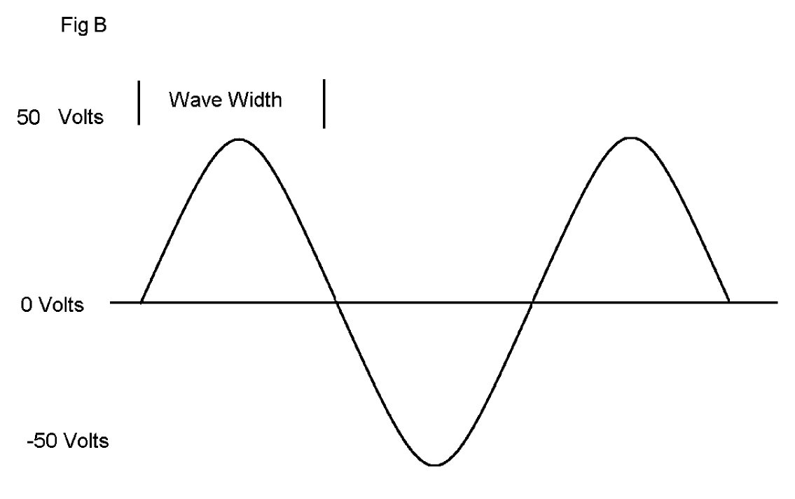

### 1. FIELD OF THE INVENTION

The present invention relates to the field of telephone monitoring systems and more particularly to a multipurpose answering machine with an “early ring detector” that can be used in but not limited to answering machines and call screening devices. This is great for people trying to sleep, for the device will answer the phone in the location before the ringers on others devices are triggered.

### 2. BRIEF DESCRIPTION OF PRIOR ART

In the past it has been usual practice for answering devices to use the voltage from the line to detect the ring. Most all telephone ring device's use the high AC voltage to charge a capacitor and send out logic of one for the ring to be detected or use the charge from a capacitor to ring a bell. Most devices answer the phone after 2-4 rings.

3.Therefore, a long-standing need has existed to provide an answering system with the ability to answer the phone before the other devices have had a chance to ring, this eliminates the disturbance from the ringers in the general area.

What is claimed is:

1. A telephone answering machine or call screening device comprising of an Early ring detector by looking at the waveform of the ring. When detected with a microprocessor or logic circuit this signal is converted from a wave to a pulse. We can measure the width of the wave or the pulse to determine a ring is being presented. This precise measurement can be used to prevent false detections and true ring detections. When we measure the width of the pulse (Fig A) or wave (Fig B) and get a true detection we know a ring is present and can answer the phone before other devices are able to trip there ring detection circuits. To help prevent false triggers the voltage must be over 10 volts, this is also a requirement of the FCC.
